(19) United States
(12) Patent Application Publication
(10) Pub. No.: US 2009/0011312 A1
(43) Pub. Date: Jan. 8, 2009

(54) FUEL CELL AND SYSTEM

(75) Inventor: Inhyuk SON, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/029,722

(22) Filed: Feb. 12, 2008

(30) Foreign Application Priority Data
Jul. 3, 2007 (KR) 2007-66425

(51) Int. Cl. H01M 8/10

(52) U.S. Cl. 429/30

(57) ABSTRACT

A the fuel cell that uses a highly concentrated fuel, comprising: a cathode electrode layer; an electrolyte membrane disposed on the cathode layer; an anode electrode layer disposed on the electrolyte membrane; an anode gas diffusion layer disposed on the anode electrode layer; a cathode gas diffusion layer formed thinner than the anode gas diffusion layer on the other surface of the cathode electrode layer; and a porous plate-shaped piezoelectric layer formed on one surface of the anode gas diffusion layer.

### CROSS-REFERENCE TO RELATED APPLICATION

This application claims benefit of Korean Application No. 2007-66425, filed Jul. 3, 2007, in the Korean Intellectual Property Office, the disclosure of which is incorporated herein by reference.

### BACKGROUND OF THE INVENTION

1. Field of the Invention

Aspects of the present invention relate to a fuel cell, and a fuel cell system, both of which having an increased efficiency and output, and using a high concentration fuel.

2. Description of the Related Art

A fuel cell is an electric power generating system that generates electrical energy, by a chemical reaction of hydrogen, contained in hydrocarbon fuel, such as, methanol and ethanol, and oxidants, such as oxygen contained in air supplied thereto. A fuel cell can be a polymer-electrolyte membrane fuel cell (hereafter, referred to as “PEMFC”) or a direct methanol fuel cell (hereafter, referred to as “DMFC”). In general, a PEMFC comprises: a stack (or a main body of the fuel cell) to generate electrical energy, by a reaction of hydrogen and oxygen; and a reformer to generate hydrogen by reforming the fuel. The PEMFC generates electricity by an electrochemical reaction of hydrogen supplied from the reformer, and air supplied from an air pump. Though the PEMFC has a high energy density and a high output, precautions must be taken when handling hydrogen gas and additional equipment (such as, a fuel reformer, etc.) is needed to reform methane, methanol, and/or natural gas into the hydrogen.

The DMFC generates electricity by an electrochemical reaction of hydrogen and oxygen by supplying a methanol fuel and air directly to the stack. The DMFC has a high energy density and a high output, and does not need the additional equipment, because the liquid fuel, such as, methanol, etc. is directly used and is easier to store and supply.

The DMFC comprises a membrane electrode assembly (hereafter, referred to as “MEA”) to generate electricity, a main body, and a gas diffusion layer laminated in the main body. The DMFC can be made variously according to the main body structure of the fuel cell and an air supplying method, and divided into an active-type and a passive-type. The active-type has a membrane electrode assembly laminated in the vertical direction, in the main body of the fuel cell, and fuel and air are supplied by pumps. The passive-type has a membrane electrode assembly that is arranged independently, or in the parallel direction, in a main body, and fuel and air are supplied by directly contacting the membrane electrode assembly.

As the passive-type fuel cell does not have a fuel circulating structure, the passive-type fuel cell has a lower electricity generating efficiency and output. Accordingly, the passive-type fuel cell uses a more concentrated fuel to heighten efficiency and output. However, if the fuel concentration is higher than 5M, there are problems that output and durability are degraded, because of increased fuel cross-over and chemical stability degradation of NAFION and HC membranes, currently used as electrolyte membranes therein.

### SUMMARY OF THE INVENTION

An aspect of the present invention provides a passive-type fuel cell having an increased efficiency and output, and which uses a highly concentrated fuel.

According to one aspect of the present invention, provided is a passive-type fuel cell system, which comprises: a membrane electrode assembly comprising an electrolyte membrane, an anode electrode layer, a cathode electrode layer, and an electrolyte membrane disposed therebetween; an anode gas diffusion layer formed on one surface of the anode electrode layer; a cathode gas diffusion layer that is thinner than the anode gas diffusion layer, disposed on a surface of the cathode electrode layer; and a porous piezoelectric layer disposed on a surface of the anode gas diffusion layer. The piezoelectric layer may deformed if a current is applied thereto. The piezoelectric layer may comprise a metal oxide selected from: lead zinc titanate (Pb(Zn,Ti)O₃, solid solution of lead zinc niobium oxide (Pb(Zn,Nb)O₃) and lead titanate (PbTiO₃), and solid solution of lead magnesium niobium oxides (Pb(Mg,Nb)O₃) and lead titanate(PbTiO₃). The piezoelectric layer may comprise polyvinyliden fluoride polymer. The piezoelectric layer may cover the corresponding surface of the anode gas diffusion layer. The piezoelectric layer may directly contact the anode gas diffusion layer. The piezoelectric layer may be separated from the anode layer by a fuel space. The piezoelectric layer may include a hydrophobic membrane disposed on a surface thereof.

According various embodiments, the hydrophobic membrane may be selected from: tetrafluoride polyethylene (PTFE), polyethylene (PE), polyprophylene (PP), polyetyleneterepthylate (PET).

According various embodiments, the fuel cell may comprise a box-shaped fuel case comprising a coupling hole to couple with the anode gas diffusion layer; a gas outlet disposed adjacent to the anode gas diffusion layer, and a second hydrophobic membrane covering the gas outlet. Gas from the anode gas diffusion layer can pass through the hydrophobic membrane and exit the case through the gas outlet.

According various embodiments, the second hydrophobic membrane is one selected from a group consisting of: tetrafluoride polyethylene (PTFE), polyethylene (PE), polyprophylene (PP), polyetyleneterepthylate (PET).

According various embodiments, the fuel cell may further comprise a plate-shaped anode gasket, disposed adjacent to the electrolyte membrane, and comprising an anode coupling hole to receive the anode gas diffusion layer; and a plate-shaped cathode gasket disposed adjacent to the electrolyte membrane, comprising a cathode coupling hole to receive the cathode gas diffusion layer. The anode gasket may be thinner than the anode gas diffusion layer. The anode gasket may have a thickness corresponding to difference between the width of the gas outlet and the thickness of the anode gas diffusion layer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view illustrating a fuel cell system, according to an exemplary embodiment of the present invention;

FIG. 2 is a cross-sectional view illustrating a fuel cell, according to an exemplary embodiment of the present invention;

FIG. 3 is a plane view illustrating the fuel cell of FIG. 2;

FIG. 4 is a cross-sectional view illustrating a fuel cell, according to another exemplary embodiment of the present invention; and

FIG. 5 is a cross-sectional view illustrating a fuel cell, according to still another exemplary embodiment of the present invention.

### DETAILED DESCRIPTION OF THE EXEMPLARY EMBODIMENTS

Reference will now be made in detail to the exemplary embodiments of the present invention, examples of which are illustrated in the accompanying drawings, wherein like reference numerals refer to the like elements throughout. The exemplary embodiments are described below in order to explain aspects of the present invention, by referring to the figures. Herein, when a first element is said to be “disposed” on a second element, the first element can directly contact the second element, or one or more other elements can be located therebetween.

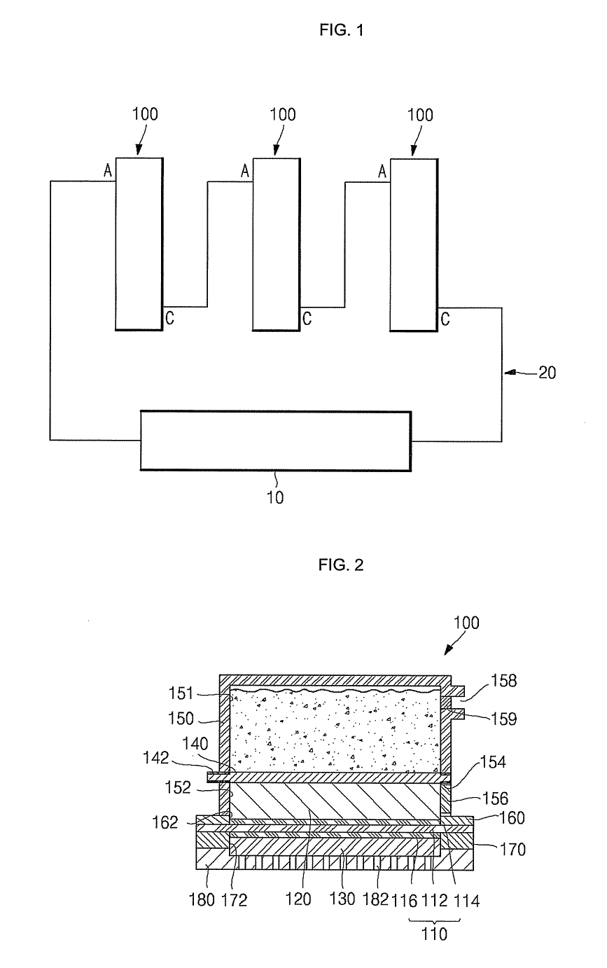

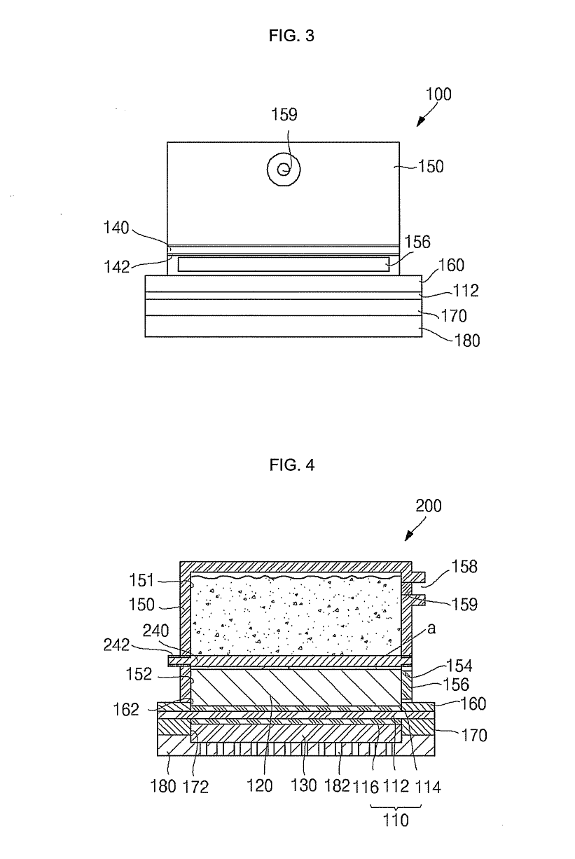

FIG. 1 is a schematic view illustrating a fuel cell system 20, according to an exemplary embodiment of the present invention, and FIG. 2 is a cross-sectional view illustrating a fuel cell 100, according to an exemplary embodiment of the present invention. FIG. 3 is a plane view illustrating the fuel cell 100, of FIG. 2. Referring to FIGS. 1 to 3, the fuel cell 100 comprises a membrane electrode assembly 110, an anode gas diffusion layer 120, a cathode gas diffusion layer 130, a piezoelectric layer 140, and a fuel case 150. The fuel cell 100 further includes an anode gasket 160 and a cathode gasket 170, disposed to cover side surfaces of the anode gas diffusion layer 120 and the cathode gas diffusion layer 130, respectively. A main body of the fuel cell 100 comprises the membrane electrode assembly 110, the anode gas diffusion layer 120, and the cathode gas diffusion layer 130. The main body generates electricity through a chemical reaction between a supplied fuel and air. An external electronic device 10, in FIG. 1, is a load connected to the fuel cells 100. The load 10 can be any electronic device drawing power generated by the fuel cells 100, and can be detachable from the cells 100 or within a common apparatus with the cells 100.

A cover 180, in FIG. 2 and FIG. 3, is installed outside of the cathode gas diffusion layer 130, so as to protect the cathode gas diffusion layer 130. The cover 180 includes pores 182 extending to the cathode gas diffusion layer 130. An oxidant, such as oxygen in air, travels through the pores 182 to the cathode gas diffusion layer 130.

The shown fuel cell 100 is a direct methanol fuel cell (DMFC). The fuel cell 100 generates electric energy, by oxidizing hydrogen contained in an alcoholic fuel, such as, methanol, ethanol, etc. and reducing the oxygen. The fuel cell system 20 includes a plurality of the fuel cells 100, as shown in FIG. 1. The fuel cell 100 is an electricity generation unit. The fuel cell 100 is a passive-type fuel cell, in which fuel is directly supplied to the membrane electrode assembly 110, and air is supplied by natural diffusion, or a convective process.

The fuel is supplied to the membrane electrode assembly 110, through the anode gas diffusion layer 120. The fuel is diluted by backward water diffusion, from water generated in the membrane electrode assembly 110, which passes through the anode gas diffusion layer 120. The anode gas diffusion layer 120 is thicker than the cathode gas diffusion layer 130, such that fuel is uniformly diluted by the water.

The fuel cell 100 comprises the piezoelectric layer 140 disposed on the anode gas diffusion layer 120. The fuel is uniformly and constantly supplied to the anode gas diffusion layer 120, by the piezoelectric layer 140. Accordingly, the fuel cell 100 can use highly concentrated fuel, of more than 5 M.

The membrane electrode assembly 110 comprises: an electrolyte membrane 112, an anode electrode layer 114, and a cathode electrode layer 116. The membrane electrode assembly 110 generates electricity by the chemical reaction of the fuel supplied from the electrode layer 114 and the air. More particularly, the membrane electrode assembly 110 generates electricity by the chemical reaction of the hydrogen contained in the fuel and the oxygen contained in the air. The membrane electrode assembly 110 can have any of the configurations generally used in fuel cells, so a detailed explanation thereof, is omitted.

The electrolyte membrane 112 is a high molecular weight membrane, formed from a high molecular weight resin having a suitable hydrogen ion conductivity. For example, the electrolyte membrane 112 is formed by high molecular weight resin, having a group selected from: a sulfonic group, a carboxylic acid group, a phosphate group, a phosphonic acid group, and derivatives thereof. The electrolyte membrane 112 includes a cation exchanger. The electrolyte membrane 112 can be formed from various resins generally used for the fuel cell, so a detailed explanation thereof, is omitted.

Hydrogen ions generated by the oxidation of the fuel are transferred to the cathode electrode layer 116, through the electrolyte membrane 112. The electrolyte membrane 112 electrically separates the anode electrode layer 114 from the cathode electrode layer 116.

The anode electrode layer 114 comprises an electrode base material and a catalyst layer formed on the electrode base material. The electrode base material includes a catalyst metal, such as, platinum, ruthenium, osmium, and/or a platinum-ruthenium alloy. The anode electrode layer 114 may comprise various electrode base materials generally used in fuel cells as a catalyst layer, so a detail explanation thereof, is omitted.

The fuel is oxidized by the catalyst layer of the anode electrode layer 114, and electrons and hydrogen ions are generated by an ionization of the fuel. The electrons are transferred to the cathode electrode layer 116, via an external circuit, and hydrogen ions are transferred to the cathode electrode layer 116, via the electrolyte membrane 112.

The cathode electrode layer 116 comprises an electrode base material and a catalyst layer disposed on the electrode base material. The electrode base material can be a carbon material, such as, graphite or acetylene black. The catalyst layer includes a catalyst metal, such as, platinum, ruthenium, osmium, and a platinum-ruthenium alloy. The oxygen, electrons, and hydrogen transferred from the anode electrode layer 114, are reduced at the cathode electrode layer 116. The electrons are conducted to the cathode electrode layer 116, via the external circuit connecting the cathode electrode layer 116 and the anode electrode layer 114. Hydrogen is transferred to the cathode electrode layer 116, via the electrolyte membrane 112. The cathode electrode layer 116 generates water and heat, by the reduction reaction.

The anode gas diffusion layer 120 may be plate-shaped and disposed on a surface of the anode electrode layer 114. The layer 120 can cover the entire surface of the anode electrode layer 114, but need not in all aspects. The anode gas diffusion layer 120 is thicker than the gas diffusion layer 120. The anode gas diffusion layer 120 is disposed in contact with a fuel stored in a fuel case 150, and supplies the fuel to the anode electrode layer 114.

The anode gas diffusion layer 120 mixes the fuel with water flowing to the anode gas diffusion layer 120, the water having been formed during a chemical reaction at the cathode electrode layer 116. The anode gas diffusion layer 120 is relatively thick, thereby extending a diffusion time for the fuel to reach the anode electrode layer 114. Accordingly, a flow rate, of the fuel supplied to the inside of the anode gas diffusion layer 120, is relatively slow, and can take hours.

The water from the cathode electrode layer 116 can be mixed with the fuel in the anode layer 120. Accordingly, the anode gas diffusion layer 120 dilutes the highly concentrated fuel supplied from the fuel case 150, with water flowing from the cathode electrode layer 116. In other words, the fuel is diluted with water generated in the membrane electrode assembly 110, as the fuel passes through the anode gas diffusion layer 120 from the fuel case 150 in an opposite direction. The anode gas diffusion layer 120 dilutes the fuel stored in the fuel case 150, to a relatively lower concentration, which is then supplied the anode electrode layer 114. Accordingly, the fuel cell 100 can use fuel having a 5M concentration, or more.

The anode gas diffusion layer 120 is thicker than the cathode gas diffusion layer 130, so as to dilute the fuel uniformly with the water. The cathode gas diffusion layer 130 is plate shaped, and is disposed on a surface of the cathode electrode layer 116. The shape of the cathode gas diffusion layer 130 corresponds to a shape of the cathode electrode layer 116. The cathode gas diffusion layer 130 has a conventional thickness. Accordingly, the cathode gas diffusion layer 130 is thinner than the anode gas diffusion layer 120. The cathode gas diffusion layer 130 is provided with air and supplies the air to the cathode electrode layer 116. Water from the cathode gas diffusion layer can be released from the fuel cell 100, for example, through an exhaust or through evaporation.

The piezoelectric layer 140 is a plate-shaped layer disposed on a surface of the anode gas diffusion layer 120. The piezoelectric layer 140 can be connected to a power supply (not shown), which supplies a current to the piezoelectric layer 140, via an electrically coupled terminal 142. The terminal 142 is formed around an end (such as an outer portion of an upper or lower surface) of the piezoelectric layer 140. The piezoelectric layer 140 is deformed by the application of the current, thereby controlling the transfer of the fuel from the fuel case 150 and/or from the anode gas diffusion layer 120.

The piezoelectric layer 140 may comprise a hydrophobic membrane disposed on a surface thereof. The piezoelectric layer 140 includes pores through which the fuel passes. The pores can be deformed by the electric current, to control the transfer the fuel. The piezoelectric layer 140 may comprise a metal oxide and/or a piezoelectric polymer. The metal oxide may be a metal oxide selected from the group consisting of: lead zinc titanate(Pb(Zn,Ti)O3, a solid solution of lead zinc niobium oxide(Pb(Zn,Nb)O3) and lead titanate(PbTiO3), and a solid solution of lead magnesium niobium oxides (Pb(Mg,Nb)O3) and lead titanate(PbTiO3). Among inorganic materials including oxide and nitride, etc., the metal oxide is a typical material that is deformed if electricity is applied. In addition, piezoelectric elements can be inorganic materials, such as, various metal oxides having piezoelectric properties.

The piezoelectric layer 140 comprising the metal oxide is made by sintering fine powders of the metal oxide, so as to uniformly form fine pores therein. Accordingly, the piezoelectric layer 140 uniformly supplies the fuel stored in the fuel case 150 to the anode gas diffusion layer 120, through the pores.

The piezoelectric layer 140 may be also formed by a piezoelectric polymer made of a polyvinyliden fluoride material. As described above, the piezoelectric layer 140 made of the piezoelectric polymer is formed with a porous plate shape. Pores passing through one surface to the other surface are uniformly formed in the piezoelectric layer 140, so that fuel in the fuel case 150 is uniformly supplied to the anode gas diffusion layer 120.

The fuel cell 100 does not use fuel supply equipment, such as a fuel pump, as is used in an active fuel cell system. The fuel cell 100 supplies fuel to the anode electrode layer 114, by the fuel diffusing through the piezoelectric layer 140 to the anode gas diffusion layer 120. However, other mechanisms can be used to alter an amount of the fuel supplied to the anode electrode layer 114, such as according to an installed direction of the fuel cell 100 and an amount of the fuel in the case 150.

The fuel in the fuel case 150 flows through the piezoelectric layer 140 and then to the anode gas diffusion layer 120. Accordingly, the piezoelectric layer 140 can uniformly supply the fuel to the anode gas diffusion layer 120. The anode gas diffusion layer 120 mixes the high concentration fuel supplied from the piezoelectric layer 140, with water from the cathode electrode layer 116. Accordingly, the anode gas diffusion layer 120 can supply a uniformly diluted fuel to the anode electrode layer 114. The anode electrode layer 114 generates electricity uniformly, thereby allowing the performance and efficiency of the fuel cell 100 to be improved.

The piezoelectric layer 140 is disposed in contact with a surface of the anode gas diffusion layer 120. The piezoelectric layer 140 is deformed by the current applied thereto. If the current is repeatedly cycled, the piezoelectric layer 140 supplies the fuel to the anode gas diffusion layer 120, through expansion and contraction of the pores. Accordingly, the piezoelectric layer 140 allows a more uniform supply of the fuel to the entire surface of the anode electrode layer 114, by applying pressure to the anode gas diffusion layer 120, when the current is applied.

The fuel case 150 is box-shaped and defines a fuel storage space 151. The fuel case 150 includes a coupling hole 152 formed in a first side thereof. The fuel case 150 includes a gas outlet 154 formed in second side thereof, which opposes the first side. A hydrophobic membrane 156 covers the gas outlet 154. The fuel case 150 includes an outlet 158, sealed by a hydrophobic membrane 159.

An end of the anode gas diffusion layer 120 is disposed in the coupling hole 152, so that the anode gas diffusion layer 120 is fixed by the coupling hole 152. The coupling hole 152 can be a depression, a hole, or the like. While not required in all aspects, the coupling hole 152 has a width that can be equal to a width of the anode gas diffusion layer 120, so that the fuel may be in contact with a broader area of the anode gas diffusion layer 120.

The gas outlet 154 is disposed adjacent to an end of the anode gas diffusion layer 120. The gas outlet 154 is formed on the second surface, which is vertically oriented, when the fuel case 150 is installed in the fuel cell 100. The gas outlet 154 has a width that can be equal to the thickness of the anode gas diffusion layer 120, or can be smaller than a thickness of the anode gas diffusion layer 120. On the other hand, the gas outlet 154 may be formed on a whole surface including an upward surface at other side of the fuel case 150. The gas outlet 154 enables carbon dioxide, generated at the anode electrode layer 114, to be emitted to the outside of the fuel case 150, via the anode gas diffusion layer 120.

The hydrophobic membrane 156 can be selectively permeable to hydrophilic molecules. The hydrophobic membrane 156 can comprise a polymer having a hydrophobic property. The polymer can be any one selected from a group consisted of tetrafluoride polyethylene (PTFE), polyethylene (PE), polyprophylene (PP), and polyetyleneterepthylate (PET), but is not limited thereto.

The hydrophobic membrane 156 emits gas, such as carbon dioxide, flowing into the anode gas diffusion layer 120, to the outside of the case 150, and shields the gas outlet 154. The hydrophobic membrane 156 also prevents the fuel from flowing through the gas outlet 154, and exiting the fuel case 150. The hydrophobic membrane 156 selectively emits gas from the anode gas diffusion layer 120, to the outside. Accordingly, the gas outlet 154 enables fuel in the fuel case 150 and water from the cathode electrode layer 116, to flow into the anode gas diffusion layer 120, more effectively.

The outlet 158 emits gases, such as carbon dioxide, that flow into the fuel storage space 151. The outlet 158 can be positioned at a top portion of the fuel storage space 151 adjacent to a space unfilled by the fuel. The hydrophobic membrane 159 is in the outlet 158 and is selectively permeable to gas. The hydrophobic membrane 159 can allow air to enter the fuel storage space 151, as the fuel is transferred through the piezoelectric layer 142.

The anode gasket 160 is plate-shaped, and has a larger surface area than the surface area of the anode gas diffusion layer 120. The anode gasket 160 comprises an anode coupling hole 162 disposed in a center region thereof. The anode gasket 160 contacts a surface of the electrolyte membrane 112, that is, a surface combined with the anode electrode layer 114. The anode gasket 160 is disposed between the electrolyte membrane 112 and an end of the fuel case 150.

The anode coupling hole 162 is shaped to correspond to an edge of the anode gas diffusion layer 120. The anode gas diffusion layer 120 is inserted into, and secured by, the anode coupling hole 162 of the anode gasket 160. Accordingly, the anode gasket 160 covers the edge of the anode gas diffusion layer 120. One surface of the anode gasket 160 contacts the fuel case 150, and another surface of the anode gasket 160 contacts the electrolyte membrane 112. The anode gasket 160 prevents fuel and moisture in the anode gas diffusion layer 120 from flowing out of the fuel cell 100. The anode gasket 160 is formed by various resins generally used for a fuel cell, so a detailed explanation thereof, is omitted.

The anode gasket 160 is thinner than the anode gas diffusion layer 120. As the anode gasket 160 covers a side surface (edge) of the anode gas diffusion layer 120, it is difficult to combine the coupling hole 152 of the fuel case 150 with the anode gas diffusion layer 120, if the anode gasket 160 is thicker than the anode gas diffusion layer 120. Accordingly, the anode gasket 160 is formed with a thickness corresponding to a difference between the width of the gas outlet 154 and the thickness of the anode gas diffusion layer 120.

The cathode gasket 170 is plate-shaped, and is larger than the cathode gas diffusion layer 130, so as to cover the gas diffusion layer 130. The cathode gasket 170 includes a cathode combined hole 172 disposed in a center region thereof. The cathode gasket 170 contacts an edge of the electrolyte membrane 112 (i.e., the cathode electrode layer 116(. The cathode combined hole 172 has a width corresponding to that of the cathode gas diffusion layer 130. The cathode gas diffusion layer 130 is secured in the cathode combined hole 172. Accordingly, the cathode gasket 170 surrounds the cathode gas diffusion layer 130. A first surface of the cathode gasket 170 contacts the fuel case 150, and a second surface of the cathode gasket 170 contacts the electrolyte membrane 112. The cathode gasket 170 prevents the fuel and the water in the cathode gas diffusion layer 130 from flowing out of the fuel cell 100. The cathode gasket 170 is formed by various resins generally used for a fuel cell, so a detailed explanation thereof, is omitted.

FIG. 4 is a cross-sectional view illustrating a fuel cell 200, according to another exemplary embodiment of the present invention. Referring to FIG. 4, the fuel cell 200 comprises a membrane electrode assembly 110, an anode gas diffusion layer 120, a cathode gas diffusion layer 130, a piezoelectric layer 240, and a fuel case 150. The fuel cell 100 further includes an anode gasket 160, which surrounds the anode gas diffusion layer 120, and a cathode gasket 170, which surrounds the cathode gas diffusion layer 130. The fuel cell 200 is similar to the fuel cell 100 shown in FIGS. 2 and 3. Accordingly, the fuel cell 200 uses the same drawing reference numbers for similar elements and a detailed explanation is not provided. Different parts in the fuel cell 200 will be mainly explained.

Referring to FIG. 4, the piezoelectric layer 240 is separated from the anode gas diffusion layer 120. In this case, a fuel space (a), to temporarily store the fuel, is formed between the piezoelectric layer 240 and the anode gas diffusion layer 120. Accordingly, the piezoelectric layer 240 supplies the fuel stored in the fuel space (a) to the anode gas diffusion layer 120 in a more effective and uniform manner.

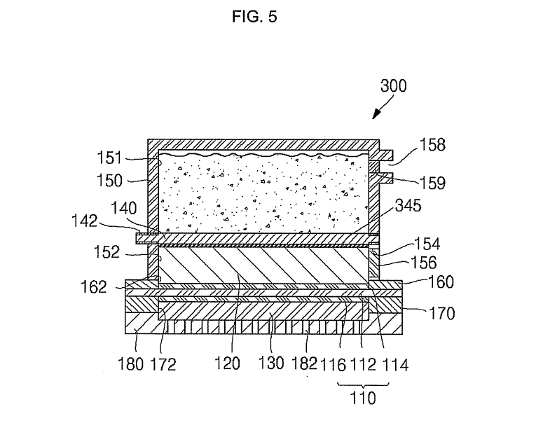

FIG. 5 is a cross-sectional view illustrating a fuel cell 200, according to still another exemplary embodiment of the present invention. Referring to FIG. 5, the fuel cell 300 comprises a membrane electrode assembly 110, an anode gas diffusion layer 120, a cathode gas diffusion layer 130, a piezoelectric layer 140, a hydrophobic membrane 345, and a fuel case 150. The fuel cell 300 further includes an anode gasket 160, which surrounds the anode gas diffusion layer 120, and a cathode gasket 170, which surrounds the cathode gas diffusion layer 130.

The fuel cell 300 is similar to the exemplary embodiments of FIGS. 2 and 3, except that the hydrophobic membrane 345 is formed on a surface of the piezoelectric layer 140. Accordingly, the fuel cell 300 uses the same drawing number for the same elements as the fuel cells 100 and 200. Different parts in the fuel cell 300 will be mainly explained.

Referring to FIG. 5, the hydrophobic membrane 345 is made of a hydrophobic resin, and is formed on the surface the piezoelectric layer 140. Although shown on a lower surface of the piezoelectric layer, the hydrophobic membrane 345 can be disposed on an opposing upper surface thereof. The hydrophobic membrane 345 prevents moisture generated at the cathode electrode layer 116, from flowing into the fuel storage space 151 of the fuel case 150. The hydrophobic membrane 345 enables moisture to remain inside the anode gas diffusion layer 120, so that fuel flowed from the fuel case 150 may be diluted more effectively.

A process of operating the fuel cell 100, according to an exemplary embodiment of the present invention, will be described. First, when the fuel is supplied to the fuel case 150, and air is supplied to the cathode electrode layer 116. An electrochemical reaction occurs in the membrane electrode assembly 110. Hydrogen is ionized at the anode electrode layer 114, by the electrochemical reaction, and electrons are conducted to the cathode electrode layer 116, through an external circuit. Hydrogen ions are conducted to the cathode electrode layer 116, through the electrolyte membrane 112.

Carbon dioxide, generated at the anode electrode layer 114, flows into the anode gas diffusion layer 120, and is then exhausted from the fuel case 150, through the gas outlet 154. The gas outlet 154 is covered by the second hydrophobic membrane 156, such that the carbon dioxide is selectively emitted through the outlet 154. Some of moisture generated at the cathode electrode layer 116 is emitted from the cathode gas diffusion layer 130 through the gas outlet 154. Some of the moisture flows into the anode gas diffusion layer 120, by passing through the membrane electrode assembly 110 and the anode electrode layer 114. The anode gas diffusion layer 120 mixes the fuel from the fuel case 150 with the water from the cathode electrode layer 116, and supplies the diluted fuel to the anode electrode layer 114.

The piezoelectric layer 140 supplies the fuel to the anode gas diffusion layer 120, through the pores uniformly formed therein. The piezoelectric layer 140 is deformed by the supplied current, such that the fuel remaining inside the anode gas diffusion layer 120 can be supplied to the anode electrode layer 114, more effectively.

A fuel cell, according aspects of the present invention, produces some or all of the following effects. First, the passive-type fuel cell can increase efficiency and output of the fuel cell, by using a highly concentrated fuel. Second, the highly concentrated fuel can be used, because the anode gas diffusion layer is thicker than the cathode gas diffusion layer, thereby diluting the highly concentrated fuel with water from the cathode electrode layer. Third, efficiency and performance of the fuel cell can be improved, by progressing an electricity generation reaction uniformly at the anode electrode layer, because the piezoelectric layer can supply fuel more uniformly to the whole region of the anode gas diffusion layer. Fourth, if a current is applied to the piezoelectric layer, the fuel in the fuel space between the anode gas diffusion layer, or anode gas diffusion layer and the piezoelectric layer, is pressurized by the piezoelectric layer, thereby allowing the fuel to be supplied to the anode electrode layer effectively. Fifth, a hydrophobic membrane is formed on the piezoelectric layer, thereby preventing moisture from the cathode electrode layer, from flowing into the inside of the fuel case, and effectively diluting the fuel flowing into the anode gas diffusion layer. However, is understood that aspects of the invention can have other effects in addition to, or instead of the above listed effects.

Although the case 150 was referred to herein as having a box-shape, the case can have any suitable shape, for example, cylindrical, rectangular, cubic, and the like. The anode gas diffusion layer 120, the cathode gas diffusion layer 130, piezoelectric layer 140, the anode gasket 160, the cathode gasket 170, are referred to has being plate shaped, but can also have any number of suitable shapes, so long as the shapes correspond with the shapes of related components and/or the shape of the case.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fuel cell comprising:
a cathode layer;
an electrolyte membrane disposed on the cathode layer;
an anode layer disposed on the electrolyte membrane;
an anode gas diffusion layer disposed on the anode layer;
a cathode gas diffusion layer that is thinner than the anode gas diffusion layer, disposed on the cathode layer; and
a piezoelectric layer disposed upon the anode gas diffusion layer, to regulate fuel passing to the anode layer.

2. The fuel cell of claim 1, wherein the piezoelectric layer is deformed by an electric current, to apply pressure to the anode gas diffusion layer.

3. The fuel cell of claim 1, wherein the piezoelectric layer comprises a metal oxide selected from a group consisting of: lead zinc titanate(Pb(Zn,Ti)O3, a solid solution of lead zinc niobium oxide(Pb(Zn,Nb)O3) and lead titanate(PbTiO3), and a solid solution of lead magnesium niobium oxides (Pb(Mg,Nb)O3) and lead titanate(PbTiO3).

4. The fuel cell of claim 1, wherein the piezoelectric layer comprises a polyvinyliden fluoride piezoelectric polymer.

5. The fuel cell of claim 1, wherein the piezoelectric layer completely covers a surface of the anode gas diffusion layer.

6. The fuel cell of claim 1, wherein the piezoelectric layer directly contacts the anode gas diffusion layer.

7. The fuel cell of claim 1, wherein the piezoelectric layer is spaced apart from the anode gas diffusion layer by a fuel space, which stores fuel between the piezoelectric layer and the anode gas diffusion layer.

8. The fuel cell of claim 1, wherein the piezoelectric layer comprises a hydrophobic membrane disposed on a surface thereof.

9. The fuel cell of claim 8, wherein the hydrophobic membrane comprises a polymer selected from a group consisting of: tetrafluoride polyethylene(PTFE), polyethylene(PE), polyprophylene(PP), and polyetyleneterepthylate(PET).

10. The fuel cell of claim 1, further comprising a fuel case to house the anode gas diffusion layer and the piezoelectric layer, the fuel case comprising:
a coupling hole disposed adjacent to the anode gas diffusion layer, in which a portion of the anode gas diffusion layer is secured;
a gas outlet disposed adjacent to the anode gas diffusion layer; and
a hydrophobic membrane disposed to cover the gas outlet.

11. The fuel cell of claim 10, wherein the gas outlet provides a pathway through the case, to release gas from the anode gas diffusion layer.

12. The fuel cell of claim 10, wherein the hydrophobic membrane comprises any one selected from a group consisted of: tetrafluoride polyethylene(PTFE), polyethylene(PE), polyprophylene(PP), and polyetyleneterepthylate(PET).

13. The fuel cell of claim 1, further comprising:
an anode gasket disposed around the anode gas diffusion layer, comprising an anode coupling hole, in which an edge of the anode gas diffusion layer is disposed; and
a cathode gasket disposed around the electrolyte membrane and the cathode gas diffusion layer, comprising a cathode coupling hole, in which an edge of the cathode gas diffusion layer is disposed.

14. The fuel cell of claim 13, wherein the anode gasket has a thickness that is less than a thickness of the anode gas diffusion layer.

15. The fuel cell of claim 13, wherein the thickness of the anode gasket corresponds to a difference between the width of the gas outlet and the thickness of the anode gas diffusion layer.

16. The fuel cell of claim 13, further comprising a cover disposed on the cathode gas diffusion layer, the cover comprising pores to distribute air to the cathode gas diffusion layer.

17. A fuel cell system comprising a plurality of the fuel cells of claim 1, connected in series.

18. A fuel cell comprising:
a case to store a fuel;
a piezoelectric layer disposed in an opening of the case, to control a flow of the fuel from the case;
an anode gas diffusion layer disposed on the piezoelectric layer, to dilute the fuel with water;
an anode layer disposed on the anode gas diffusion layer, to receive electrons from the diluted fuel;
an electrolyte membrane disposed on the anode layer to separate the electrons from protons in the fuel;
a cathode layer disposed on the electrolyte membrane, to produce the water using the protons, the electrons, and oxygen;
a cathode gas diffusion layer that is thinner than the anode gas diffusion layer, disposed on the cathode layer, to provide the oxygen to the cathode layer;
wherein the piezoelectric layer comprises pores through which the fuel passes and applies pressure to the anode gas diffusion layer to control the flow of the fuel.

19. The fuel cell of claim 18, wherein the piezoelectric layer further comprises a hydrophobic membrane to prevent the water from mixing with the fuel in the case.

20. The fuel cell of claim 18, wherein the piezoelectric layer is spaced apart from the anode gas diffusion layer by a fuel space, and the piezoelectric layer applies the pressure to fuel disposed in the fuel space.
